(19) United States
(12) Patent Application Publication
(10) Pub. No.: US 2010/0121518 A1
(43) Pub. Date: May 13, 2010

(54) MAP ENHANCED POSITIONING SENSOR SYSTEM

(76) Inventors: Timothy Arthur Tiernan, Livonia, MI (US); Faroog Abdel-kareem Ibrahim, Dearborn Heights, MI (US); Kenneth Aaron Freeman, Ann Arbor, MI (US)

Correspondence Address: FRASER CLEMENS MARTIN & MILLER LLC, 28366 KENSINGTON LANE, PERRYSBURG, OH, 43551, US

(21) Appl. No.: 12/268,932

(22) Filed: Nov. 11, 2008

(51) Int. Cl. G01C 21/34

(52) U.S. Cl. 701/26; 701/213; 701/209

(57) ABSTRACT

An enhanced positioning system includes a vehicle positioning system adapted to transmit an output representing at least one of a current position, a future position, and a path of a vehicle and at least one module in communication with the vehicle positioning system, wherein the at least one module obtains data and information related to at least one of a road attribute, a vehicle dynamics, and a vehicle position, analyzes the data and information, and modifies the output of the vehicle positioning system in response to the analysis of the data and information.

### FIELD OF THE INVENTION

The invention relates to vehicle positioning systems. More particularly, the invention is directed to a map enhanced positioning sensor system and a method for determining an accurate instantaneous position of a vehicle and an accurate prediction of the future position of a vehicle.

### BACKGROUND OF THE INVENTION

Many advanced driver awareness systems (ADAS), also known as driver assistance systems or active safety systems, would benefit from more accurate and timely information about both a current and a future vehicle position in real-time.

Currently, most applications that require real-time position information use a position derived from a Global Positioning System (GPS) supplemented with dead reckoning (DR). In addition the DR provides positioning inputs when GPS satellite signals are not available. Time delays and other errors can be introduced from many sources including atmospheric conditions, environmental conditions, vehicle yaw, speed and steering angle sensors, and computational latency.

Typically, such a GPS/DR system fuses data from GPS, a yaw rate sensor and a vehicle speed sensor. The calculated GPS/DR position is then matched to a position within a map segment in the map database. This position is referred to as a map-matched position. Current commercial maps represent undivided roads as a single line, and divided roads with two lines (one line for each direction). As such, each line on the map represents the center of the represented road segment. Therefore, the accuracy of the map-matched position is affected by four main factors and associated errors: 1) matching the position to the correct road segment; 2) the accuracy of the GPS/DR position; 3) the distance between the equipped vehicle and the center of the road; and 4) errors contained within the map database itself.

To improve ADAS applications each of the errors must be minimized. Further, existing positioning systems provide only the current or present position. ADAS systems require both a more accurate current position and the position projected at various future times.

It would be desirable to have an enhanced vehicle positioning system and method for determining a vehicle position and travelling path, wherein the system and method leverage road attributes, vehicle dynamics, and vehicle position data to minimize positioning errors and maximize accuracy.

### SUMMARY OF THE INVENTION

Concordant and consistent with the present invention, an enhanced vehicle positioning system and method for determining a vehicle position and travelling path, wherein the system and method leverage road attributes, vehicle dynamics, and vehicle position data to minimize positioning errors and maximize accuracy has surprisingly been discovered.

In one embodiment, an enhanced positioning system comprises: a vehicle positioning system adapted to transmit an output representing at least one of a current position, a future position, and a path of a vehicle; and at least one module in communication with the vehicle positioning system, wherein the at least one module obtains data and information related to at least one of a road attribute, a vehicle dynamics, and a vehicle position, analyzes the data and information, and modifies the output of the vehicle positioning system in response to the analysis of the data and information.

In another embodiment, an enhanced positioning system comprises: a vehicle positioning system adapted to transmit an output representing at least one of a current position, a future position, and path of a vehicle, wherein the vehicle positioning system includes at least one of a map database for providing pre-determined map data, a Global Positioning System for determining the position of the vehicle in a pre-determined coordinate system, a vehicle sensor for providing data related to vehicle dynamics, a map-matching module for determining a vehicle positioning module on a pre-determined map, and a look-ahead module which determines a candidate list of probable driving paths and from the candidate list determines the most likely path of the vehicle; and at least one module in communication with the vehicle position system, wherein the at least one module obtains data and information related to at least one of a road attribute, a vehicle dynamics and a vehicle position, analyzes the data and information, and modifies the output of the vehicle positioning system in response to the analysis of the data and information.

The invention also provides methods for determining a vehicle position and travelling path.

One method comprises the steps of: providing an output representing at least one of a current position, a future position, and a travelling path of a vehicle; evaluating the output in response to data and information relating to at least one of a road attribute, a vehicle dynamics, and a lane position; modifying the output in response to the data and information; and generating at least one of an instantaneous vehicle position with lane position, a future vehicle position at a predetermined time in the future, a future vehicle position along a calculated look-ahead distance, a future vehicle position at a requested time in the future, and a plurality of future vehicle positions at predetermined times in the future for multiple paths in response to the modified output.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic diagram of a vehicle positioning system according to the prior art; and

FIG. 2 a schematic diagram of a map enhanced positioning sensor system according to an embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the at to make and use the invention, and are not intended to limit the scope of the invention in any manner. In respect of the methods disclosed, the steps presented are exemplary in nature, and thus, the order of the steps is not necessary or critical.

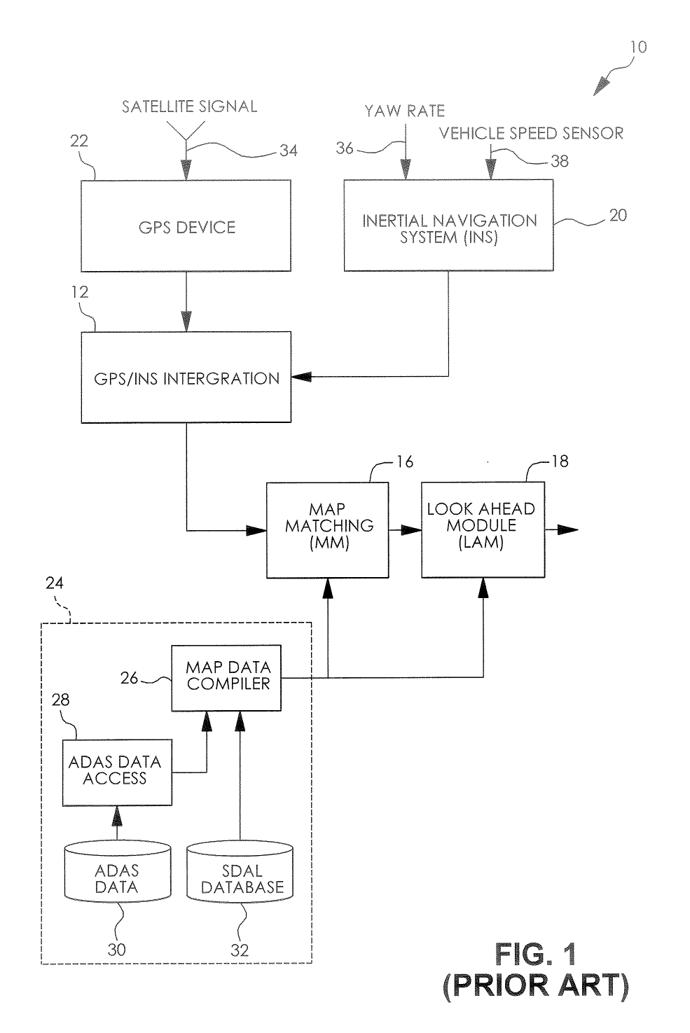

Referring to FIG. 1, there is illustrated a vehicle positioning system 10 for providing a vehicle position and predicted path of travel, according to the prior art. As shown, the vehicle positioning system 10 includes a global positioning system (GPS), a GPS/INS integration module 12, a map-matching module 16, and a look-ahead module 18. The system 10 is also provided with an inertial navigation system 20, a GPS receiver 22, a map database 24, a yaw rate sensor 36, and a vehicle speed sensor 38. The map database 24 includes a map data compiler 26 and an ADAS data access 28 that receives information from an ADAS data base 30. The map data complier 26 also receives information from an SDAL database 32. The map database 24 may be a database, now known or later developed.

The GPS receiver 22 receives satellite information 34 related to the vehicle GPS position. In the GPS/INS integration module 12, the GPS position is augmented using, for example, a Kalman filter, with the yaw rate and the vehicle speed obtained through the inertial navigation system 20. As such, the GPS/INS integration module 12 provides information related to an integrated position solution including a vehicle position calculated in a global coordinate system and vehicle dynamics such as yaw rate and vehicle speed, for example. It is understood that, other data and information related to vehicle dynamics and position may be used.

The map-matching module 16, implemented with a map-matching algorithm, receives the integrated position solution from the integration module 12 and information from the map database 24 to calculate the vehicle position on a pre-determined map. The look-ahead module 18 then receives the map position information from the map-matching module 16, as well as information from the map database 24, and “looks ahead” in the map from the calculated map position to calculate a candidate list of probable intended driving paths, in particular, a most likely path (MLP) based on various probabilities.

Specifically, the look-ahead module 18 determines the most probable path and other alternate paths of the vehicle employing, for example, information from a map-matched position, lane information, lateral velocity, and vehicle signals such as turn signals, brake signals, and various states of the vehicle. The vehicle information can be evaluated using a cost function to assign a weight to each parameter with respect to the consideration that the parameter will have when predicting the vehicle's most likely path. Other functions and methods may be used to evaluate the vehicle information and determine the MLP.

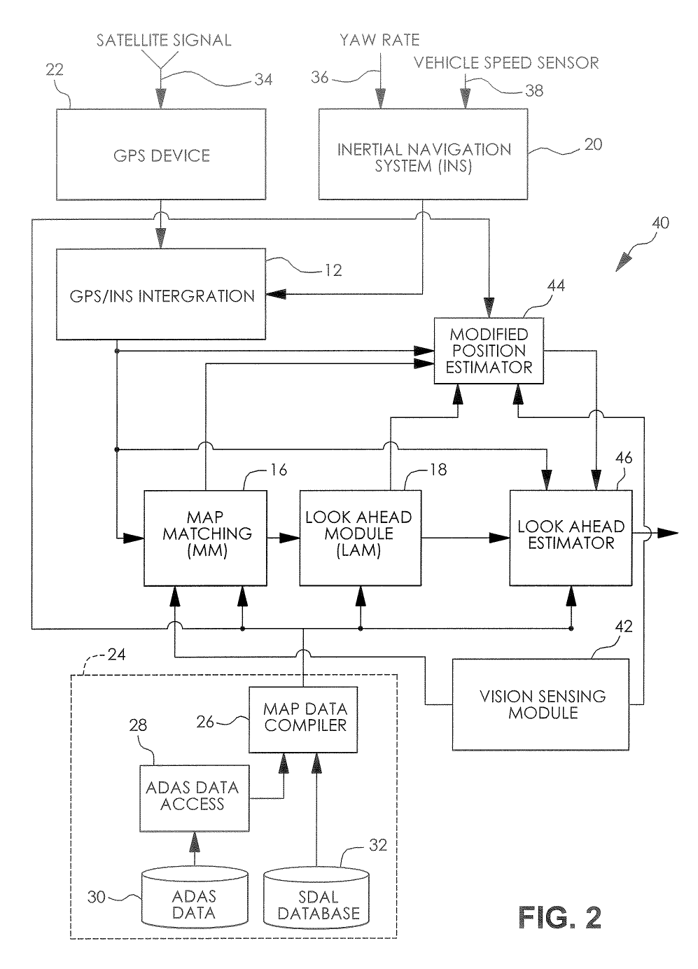

FIG. 2 illustrates a map enhanced positioning sensor system (MEPSS) 40 according to an embodiment of the present invention. As shown, the MEPSS 40 includes a vision sensing module 42, a modified position estimator 44, and a look-ahead position estimator 46, wherein each of the vision sensing module 42, the modified position estimator 44, and the look-ahead position estimator 46 is integrated with and in data communication with the vehicle positioning system 10. It is understood that the MEPSS 40 may include additional components, systems and devices, as desired. It is further understood that the vision sensing module 42, the modified position estimator 44, and the look-ahead position estimator 46 of the MEPSS 40 may be integrated with any vehicle positioning system or driver assistance and awareness system, now known or later developed. As a non-limiting example, the vision sensing module 42, the modified position estimator 44, and the look-ahead position estimator 46 of the MEPSS 40 may be integrated with the systems described in commonly owned U.S. Pat. Appl. Pub. Nos. 2007/0052555, 2005/0251335, 2008/0239734, 2008/0239698, and 2006/0178824, each of which is hereby incorporated herein by reference in its entirety. It is understood that other warning systems, driver awareness systems, active safety system, collision avoidance systems, and driver alert systems may be used, as desired.

The vision sensing module 42 illustrated is a forward-looking vision sensor. As a non-limiting example, the vision sensing module 42 includes a lens with a field of view of 50 degrees, a semiconductor imager with at least 300,000 pixels, and a processor able to support 30 frames per second operation. Other lenses, cameras, imagers and processors may be used. As shown, the vision sensing module 42 is in communication with the map-matching module 16 and the modified position estimator 44. In certain embodiments, the vision sensing module 42 detects the surrounding environment of the vehicle and recognizes any lane boundary markings. As such, the vision sensing module 42 provides data and information related to the surrounding environment of the vehicle. For example, by processing the location of the boundary markings within the pre-determined field of view, the vision sensing module 42 is able to determine a position and a relative velocity of the vehicle relative to a center of the travelling lane. It is understood that the vision sensing module 42 may be calibrated to obtain readings from any location or orientation in the vehicle. Further, the vision sensing module 42 may be calibrated to turn on and off with the vehicle and to interface with in-vehicle data buses or in-vehicle data exchange systems.

The modified position estimator 44 is in communication with the integration module 12, the map-matching module 16, the look-ahead module 18, the map database 24, the vision sensing module 42, and the look-ahead estimator 46. As such, the modified position estimator receives the MLP, speed, yaw rate, lane count, and the outputs of the vision sensing module 42, and generates an enhanced vehicle position, referred to as a modified vehicle position (PMOD). It is understood that the modified position estimator 44 may receive other information and data related to the vehicle, road attributes, and the surrounding environment from any device, system, or component. For example, the vehicle may include sensors for detecting and transmitting vehicle information such as yaw rate and vehicle speed.

The look-ahead estimator 46 illustrated is in communication with the integration module 12, the look-ahead module 18, the map database 24, and the modified position estimator 44. However, it is understood that other configurations for data sharing may be used. As such, the look-ahead estimator 46 receives data and information related to the vehicle position the MLP, a plurality of road attributes, a surrounding environment, and a vehicle dynamics data such as yaw rate and speed, for example. The look-ahead estimator 46 then analyzes the data and information, and extrapolates a vehicle path including predictions of future vehicle position. It is understood that the look-ahead estimator 46 may receive information and data related to the vehicle, road attributes, and the surrounding environment from any device, system, or component.

In use, the look-ahead module 18 generates the MLP. Specifically, the look-ahead module 18 scans a plurality of upcoming potential routes from the perspective of the vehicle position at a pre-determined look-ahead distance. The look-ahead module 18 determines the MLP of the vehicle using information such as vehicle positioning, lane information, lateral velocity, and vehicle signals and conditions. As such, the MLP provides data related to future vehicle positioning and travelling path.

Additionally, the vision sensing module 42 obtains and transmits real-time information related to a lane boundary type, a lane width, a vehicle position relative to the lane of travel, a lateral velocity, and a vehicle heading with respect to the center of the travelling lane (i.e. lane center). As such, the vision sensing module 42 provides data and information to components of the MEPSS 40, the data including: a lane center, a lane width, a position in the lane relative to the lane center, a vehicle yaw attitude relative to the lane center, a lane boundary and marking types, a number of lanes in the direction of travel, a scene tracking, and a prediction of a lane change. Other information may be obtained, measured, and transmitted by the vision sensing module 42. For example, the vision sensing module 42 may provide confidence measures for all outputs.

The modified position estimator 44 receives data and information from the integration module 12, the map-matching module 16, the look-ahead module 18, the map database 24, and the vision sensing module 42. It is understood that the modified position estimator 44 may receive data and information from other devices, components and systems such as vehicle sensors, for example. The Modified Position Estimator 44 provides an accurate vehicle position by the fusion of data such as the MLP, data from the vision sensing module 42, map road attributes, vehicle signals, and vehicle dynamics, for example. It is understood that the position may include lane level accuracy. In certain embodiments, the MLP provides future vehicle positioning data, the data from the vision sensing module 42 provides a vehicle position, velocity and orientation with respect to the travelling lane, as well as, information regarding the actual lane of travel. Additionally, data from the integration module 12 and vehicle sensors capture the instantaneous dynamics of the vehicle such as yaw rate and speed, for example. The road attributes from the map such as number of lanes (lane count), and the road divided/undivided flag are also combined in the data fusion of the modified position estimator 44.

As a non-limiting example, the modified position estimator 44 determines the current travelling lane of the vehicle and whether the vehicle is executing a lane change based on the original MLP generated by the look-ahead module 18, the real-time number of lanes, the lane boundary type, the lane width, and the lane count from the map database 24. The modified position estimator 46 then combines the lane data and lane change data with the received in-lane position from the vision sensing module 42 to determine the PMOD including in-lane accuracy. It is understood that the actual current position is detected by the vision sensing module 42, as are many other parameters of the real road. Hence, the vision sensing module 42 provides a type of feedback, where the real-world result can be evaluated against the predicted value.

The look-ahead estimator 46 extrapolates a modified vehicle path in light of the PMOD, including in-lane accuracy, and generates an estimate of the current vehicle position and a predicted vehicle position at a pre-determined time or series of pre-determined times. As a non-limiting example, the look-ahead estimator 46 may be queried to predict a future vehicle position at a specified time in the future. It is understood that such predictions can be very accurate within a pre-determined window relative to the current vehicle position, and show a declining accuracy as the prediction interval increases.

In certain embodiments, digital map data is retrieved from the map database 24 and used to identify the position of the road centerline and/or other road attributes, allowing the MPESS 40 to have a reference and thereby limiting the error of the present position and future position projections of the vehicle. Road attributes such as number of lanes, the calculated curvature and available paths, and several key vehicle dynamics and signals are used as inputs to reduce overall errors in the MPESS 40. By combining established values of road parameters, such as lane count from the map database 24, with real-time measurements of similar parameters such as a number of detected lanes from the vision sensing module 42, the effects of the errors in the MPESS 40 are minimized to generate enhanced and modified outputs with maximized accuracy.

For driver assistance and driver awareness applications, accurate instantaneous vehicle positioning is not enough and a determination of the predicted vehicle position is essential. With the incorporation of the look ahead module 18, the vision sensing module 42, the modified position estimator 44, and the look-ahead position estimator 46, the MEPSS 40 provides an instantaneous (current) position, a future position at a predetermined point in the future, at least one future position along a calculated look ahead distance, a future position at a requested time in the future, at least one future position for multiple paths (when the road geometry presents path choices), and confidence estimates for all of the outputs of the MEPSS 40.

It is understood that different levels of module and data fusion may be used. For example, where the vision sensor information is not available due to poor visibility and/or poor road markings, the MEPSS 40 initially assumes that vehicle is driving in the center of the road. Leveraging the yaw rate and speed data combined with the calculated curvature of the road segment (obtained from the map database shape points) the MEPSS 40 can capture the lateral movement and distance from the center of the road segment. Over time, and with additional data related to road attributes (e.g. lane count), the MEPSS 40 can estimate with some confidence the lateral distance from the real center of the road to the vehicle. Alternatively, where the vision sensor information is available, the accuracy of the determined position will be improved ad confidence will be higher.

The MPESS 40 refines vehicle position and path models to predict the most likely path, latitude/longitude at various times, lane change transition, present and future heading angle, and present and future road curvature. The MPESS 40 is adapted to operate in various conditions, with or without GPS satellite signals, with or without high definition or low definition digital maps.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. An enhanced positioning system comprising:
a vehicle positioning system adapted to transmit an output representing at least one of a current position, a future position, and a path of a vehicle; and
at least one module in communication with the vehicle positioning system, wherein the at least one module obtains data and information related to at least one of a road attribute, a vehicle dynamics, and a vehicle position, analyzes the data and information, and modifies the output of the vehicle positioning system in response to the analysis of the data and information.

2. The enhanced positioning system according to claim 1, wherein the vehicle positioning system includes a map database for providing map data to the vehicle positioning system and the at least one module.

3. The enhanced positioning system according to claim 1, wherein the vehicle positioning system includes at least one of a Global Position System for determining a position of the vehicle in a pre-determined coordinate system and a vehicle sensor for providing data related to the vehicle dynamics.

4. The enhanced positioning system according to claim 1, wherein the vehicle positioning system includes a map-matching module for determining a position of the vehicle on a pre-determined map.

5. The enhanced positioning system according to claim 1, wherein the vehicle positioning system includes a look-ahead module which determines a candidate list of probable driving paths and determines the most likely path of the vehicle based on the candidate list.

6. The enhanced positioning system according to claim 1, wherein the at least one module is a vision sensing module which detects the surrounding environment of the vehicle and provides data and information related to the surrounding environment of the vehicle to other components of the vehicle.

7. The enhanced positioning system according to claim 1, wherein the at least one module is a modified positioning estimator which determines a refined vehicle position on the road including in-lane accuracy.

8. The enhanced positioning system according to claim 1, wherein the at least one module is a look-ahead estimator which extrapolates a modified vehicle path, including in-lane accuracy, and generates a predicted future vehicle position.

9. The enhanced positioning system according to claim 1, wherein the data and information includes at least one of a lane center, a lane width, a current travelling lane, a vehicle position in the travelling lane relative to the lane center, a vehicle yaw attitude relative the lane center, a lane boundary type, a number of lanes in the direction of travel, a scene lateral tracking, a prediction of a lane change, and whether the vehicle is executing a lane change.

10. An enhanced positioning system comprising:
a vehicle positioning system adapted to transmit an output representing at least one of a current position, a future position, and path of a vehicle, wherein the vehicle positioning system includes at least one of a map database for providing pre-determined map data, a Global Positioning System for determining the position of the vehicle in a pre-determined coordinate system, a vehicle sensor for providing data related to vehicle dynamics, a map-matching module for determining a vehicle positioning module on a pre-determined map, and a look-ahead module which determines a candidate list of probable driving paths and from the candidate list determines the most likely path of the vehicle; and
at least one module in communication with the vehicle position system, wherein the at least one module obtains data and information related to at least one of a road attribute, a vehicle dynamics, and a vehicle position, analyzes the data and information, and modifies the output of the vehicle positioning system in response to the analysis of the data and information.

11. The enhanced positioning system according to claim 10, wherein the at least one module is a vision sensing module which detects the surrounding environment of the vehicle.

12. The enhanced positioning system according to claim 11, wherein the vision sensing module detects at least one of a lane change, a vehicle position relative to a lane center, a lane boundary or marker type, a number of lanes in the travelling direction, and a scene tracking.

13. The enhanced positioning system according to claim 10, wherein the at least one module is a modified positioning estimator which determines a refined vehicle position on the road including in-lane accuracy.

14. The enhanced positioning system according to claim 10, wherein the at least one module is a look-ahead estimator which extrapolates a modified vehicle path, including in-lane accuracy, and generates a predicted vehicle position at a pre-determined time.

15. The enhanced positioning system according to claim 14, wherein the look-ahead estimator generates at least one of an instantaneous (current) vehicle position, a future vehicle position at a predetermined point in the future, a future vehicle position at a requested time in the future, and a plurality of future vehicle positions at predetermined times in the future for multiple paths.

16. The enhanced positioning system according to claim 10, wherein the data and information includes at least one of a lane center, a lane width, a current travelling lane, a vehicle position in the travelling lane relative to the lane center, a vehicle yaw attitude relative the lane center, a lane boundary type, a number of lanes in the direction of travel, a scene lateral tracking, a prediction of a lane change, and whether the vehicle is executing a lane change.

17. A method for determining a vehicle position and travelling path, the method comprising the steps of:
providing an output representing at least one of a current position, a future position, and a travelling path of a vehicle;
evaluating the output in response to data and information relating to at least one of a road attribute, a vehicle dynamics, and a vehicle position;
modifying the output in response to the data and information; and
generating at least one of an instantaneous vehicle position with lane position, a future vehicle position at a predetermined point in the future, a future vehicle position at a requested time in the future, and a plurality of future vehicle positions at predetermined times in the future for multiple paths in response to the modified output.

18. The method according to claim 17, wherein the output is generated by a vehicle positioning system including at least one of a map database for providing pre-determined map data, a Global Positioning System for determining the position of the vehicle in a pre-determined coordinate system, a vehicle sensor for providing data related to vehicle dynamics, a map-matching module for determining a vehicle positioning module on a pre-determined map, and a look-ahead module which determines a candidate list of probable driving paths and from the candidate list determines the most likely path of the vehicle.

19. The method according to claim 18, wherein the output is modified by at least one module adapted to obtain the data and information, analyze the data and information and modify the output in response to the analysis of the data and information.

20. The method according to claim 18, wherein the data and information includes at least one of a lane center, a lane width, a current travelling lane, a vehicle position in the travelling lane relative to the lane center, a vehicle yaw attitude relative the lane center, a lane boundary type, a number of lanes in the direction of travel, a scene lateral tracking, a prediction of a lane change, and whether the vehicle is executing a lane change.
